(19) United States
(12) Patent Application Publication
(10) Pub. No.: US 2002/0180600 A1
(43) Pub. Date: Dec. 5, 2002

(54) Garage door remote monitoring system

(76) Inventors: Ronnie L. Kirkland, Jacksonville, FL (US); Benjamin M. Rubin, Jacksonville Beach, FL (US); Percy F. Shadwell JR., Jacksonville, FL (US)

Correspondence Address: Arthur G. Yeager, P.A., Suite 1305, 112 West Adams Street, Jacksonville, FL, 32202-3853, US

(21) Appl. No.: 09/866,214

(22) Filed: May 29, 2001

(51) Int. Cl. G08B 13/08

(52) U.S. Cl. 340/545.1; 340/539; 340/686.3; 340/3.2

(57) ABSTRACT

A remote monitoring system for determining and transmitting information indicating the status of a door movable to a plurality of positions or alternatively, an alarm system includes sensor for determining each position of a door and providing output signals indicative of each position detected, a transmitter responsive to the output signal and repetitively transmitting a broadcast signal indicative of the output signal received, a first timer operatively connected to the transmitter means for selectively controlling periodic transmission of the broadcast signal in accord with first time intervals as established by the first timer means. A receiver receives the broadcast signal and includes a second timer for periodically energizing the receiver at predetermined second time intervals as established by the second timer to allow for reception of the broadcast signal. Energy management includes synchronization circuitry, which synchronizes the energization of the receiver means with the transmission of the broadcast signal by the transmitter means. The synchronizing circuitry is responsive to the reception of a broadcast signal by the receiver and includes the capability for selectively resetting the second timer in response to the reception of the broadcast signal to provide that the second time intervals occur substantially with the first time intervals.

### CROSS REFERENCE TO RELATED APPLICATION

Not Applicable.

### STATEMENT REGARDING FEDERALLY SPONSORED RESEARCH OR DEVELOPMENT

Not Applicable.

### REFERENCE TO A MICROFICHE APPENDIX

Not Applicable.

### BACKGROUND OF THE INVENTION

1. Field of the Invention

The present invention relates to garage door monitoring systems and particularly to those that provide for remote monitoring with a data display.

2. Related Art

Many devices exist in the prior art to monitor home security where occupants are present. What is desired is a system that provides for remote monitoring of a garage door when an occupant is away from the area. Such receivers should be portable and have a self-contained battery power supply. This device must provide for reliability, compliance with FCC laws and regulations and energy conservation to maximize battery life. None of the remote monitoring devices known in the prior art satisfy these requirements.

### BRIEF SUMMARY OF THE INVENTION

In one aspect of the present invention there is provided a remote monitoring system for determining and transmitting information indicating the status of a door movable to a plurality of positions comprising sensor means for determining each position of a door and providing an output signal indicative of each position detected. The transmitter means is responsive to the output signal and repetitively transmits a broadcast signal indicative of the output signal received. First timer means is operatively connected to the transmitter means for selectively controlling periodic transmission of the broadcast signal in accord with first time intervals as established by the first timer means. Receiver means is provided for receiving the broadcast signal and includes second timer means for periodically energizing the receiver means at predetermined second time intervals as established by the second timer means to allow for reception of the broadcast signal. Synchronizing means provides for synchronizing the energization of the receiver means with the transmission of the broadcast signal by the transmitter means.

It is also provided that the synchronizing means includes means for selectively resetting the second timer means to establish the second time intervals to occur substantially simultaneously with the first time intervals. The synchronizing means is responsive to the reception of the broadcast signal by the receiver means and further includes means for selectively resetting the second timer means in response to the reception of the broadcast signal to provide that the second time intervals occurs substantially simultaneously with the first time intervals. The transmitter means transmits a first broadcast signal at first time intervals when the sensor means provides an output signal indicating that a door is fully open. The transmitter means transmits a second broadcast signal at first time intervals when the sensor means provides an output signal indicating that a door is fully closed. The transmitter means transmits a third said broadcast signal when the sensor means provides an output signal indicating that a door is neither fully open nor fully closed.

The receiver means includes means for maintaining the receiver means energized for a third time interval after reception of the third broadcast signal by the receiver means. The third time interval is a multiple of the first time interval. The receiver means has third timer means for establishing third time intervals for selectively energizing the receiver for a third time interval if the broadcast signal is not received by the receiver means for a predetermined time period as established by the receiver means. The receiver means further includes indicating means responsive to reception of the broadcast signal for indicating a position of a door. The indicating means includes audible alarm means for providing an audible alarm if the broadcast signal is not received by the receiver within a predetermined time period and a door is not indicated as being in a predetermined position as established by the receiver means.

In other aspects of the present invention there is provided a method of remotely monitoring the status of a door movable to a plurality of positions comprising the steps of: detecting the position of a door; periodically transmitting a signal indicative of the position detected; periodically enabling the reception of the signal transmitted at a remote location; and synchronizing the enabling of reception with the transmission of a signal so that the steps occur substantially simultaneously. Additional steps include periodically energizing a receiver responsive to the signal transmitted; creating time intervals for periodic transmission with a resettable first timer; resetting the first timer upon movement of the door to a predetermined position; creating time intervals that determine when the receiver will be energized with a resettable second timer; resetting the second timer upon reception of a selected transmitted signal as established by the receiver; providing an audible alarm if the door is detected as being open and there has been no reception of a transmitted signal for a predetermined time period; and indicating the position of a door detected at the remote location.

### BRIEF DESCRIPTION OF THE SEVERAL VIEWS OF THE DRAWING

The novel features which are believed to be characteristic of this invention are set forth with particularity in the appended claims. The invention itself, however, both as to its organization and method of operation, together with further objects and advantages thereof, may best be understood by reference to the following description, taken in connection with the accompanying drawings, in which:

FIG. 1 is a block diagram of the transmitter assembly in accord with the present invention;

FIG. 2 is a block diagram of the receiver assembly in accord with the present invention; and

FIGS. 3-6 are flow charts illustrating the operation of the assemblies of FIGS. 1 and 2.

### DETAILED DESCRIPTION OF THE INVENTION

Introduction

Home security constantly is in need of improvement. Access that can be easily overlooked is the garage. As a person exits the garage, that person may or may not remember to use the remote control to command or order the door closed. Also, the door could malfunction or encounter an obstacle as it was attempting to close. Thus, the person may assume the door is closed when it is not. The present invention is intended to provide the driver of a garage-kept vehicle with a source of feedback as to the exact status of the garage door. The system is adaptable to monitor other entrances as well as the garage and other alarm systems. Features of this embodiment include those designed to reduce the cost of the system. In addition, the device needs to have a fairly long battery life. Features of this embodiment are designed to enhance battery life.

Transmitter

The transmitter is mounted in the garage and is powered by the main electric supply through a small low voltage power block. It is recommended that the transmitter be mounted in a location that will enhance its transmitting range to the vehicle as it exits to the road. It must be close enough to a source of AC power to attach the power block, and it must be close enough to the door sensors so that those wires may be connected to the transmitter. It is recommended that this unit not be mounted near a structure or near other devices that will reduce its transmitting range. The system requires input from sensors that supply information about the garage door status. These sensors could be micro-switches mounted in such a way that two of them could be used to detect when the door is fully closed, and when the door is fully open. Other embodiments might use magnetic reed switches or Hall effect devices. The transmitter is assembled from standard off the shelf components. A micro-controller (MCU) is used to monitor the sensor inputs and to run the code to implement the algorithms described below. The transmitter employs a pre-assembled transmitter module capable of the desired range. In the preferred embodiment the modulation used is selected for the best compromise of cost, range and speed. The MCU will provide a 5-volt logic signal to the transmitter module of the data stream that is to be transmitted.

Transmitter Operation

1. Typically, the transmitter will send the unit ID (16 bits), the door status (2 bits), and CRC (TBD bits) every ten seconds. This period is selected due to an FCC off time requirement in the 300-500 MHz bands. RF modules in this band are among the least expensive. The unit ID is permanently set by the manufacturer.

2. When the door closed sensor changes from the closed state to the not closed state, on the next scheduled transmission (ten-second period ends) the data packet will reflect a ‘00’ door state meaning that neither sensor is activated.

3. When the door is fully open, the open door sensor will activate and the transmitter will send this data, ‘01’ door state, immediately. On this event the ten second transmit timer with re-synchronize for subsequent scheduled transmission.

4. When the door begins to close, the door open sensor will deactivate and on the next scheduled transmission (ten-second period ends), the data packet will reflect a ‘00’ door state meaning that neither sensor is activated.

5. When the door fully closed, the door closed sensor will activate and the transmitter will immediately send this data, a ‘10’ door state. On this event the ten-second transmit timer will re-sychronize for subsequent scheduled transmissions.

6. If the transmitter unit determines a system fault, the scheduled transmissions will show a ‘11’ door state.

Receiver

The receiver will be operated on internal batteries and is designed to improve battery life. It is recommended that the receiver be mounted on the sun visor, or other position that allows good radio reception. The design may include an external antenna monopole. Mounting must also accommodate reading the LCD display. The receiver employs an LCD display that continuously shows the door and/or system status. There is also a small piezo electric beeper to signal certain conditions. The receiver is built from standard “off-the-shelf” components and modules. There is a microcontroller (MCU) to do timing functions, power management, signal decoding, and to drive the display and annunciator. The RF receiver module is selected to match the modulation scheme of the transmitter and to provide the data rate and range required. The MCU is selected to be able to power the receiver module from a programmable output, and has a low-power operating mode in order to minimize power consumption between receiving cycles.

Receiver Operation

1. The key to the energy conservation strategy is to keep a clock in the receiver synchronized with the clock in the transmitter. The receiver clock is re-calibrated and re-synched as each data packet is received. This provides protection of the effects of time and temperature instability. To improve the likelihood that the receiver will be energized when a packet arrives from the transmitter, the receiver module will be energized for a time earlier and later than the expected arrival time of the next packet, thus providing a window of reception. The size of this window will be optimized based on the worst-case instability of the transmitter and receiver clocks.

2. Learning mode is initiated by a system reset. In this mode the receiver will listen continuously for an RF data packet for up to ten minutes. When one is received, the receiver adopts the ID number received for itself and will ignore future data packets with a different ID code. During this mode it also does the initial calibration of its internal clock with respect to the transmitters' clock. To accomplish this, when the first packet is received a local counter is started and when the second packet arrives it is stopped. This count becomes the standard for the wait timer that controls the down time between packets.

3. To comply with FCC regulations and reduce power consumption, all packets will be transmitted on a schedule of once every ten seconds. The only packets that will not arrive on this schedule (asynchronously) are the first packets transmitted upon the door reaching the fully open position or the door reaching the fully closed position. Every time two consecutive packets are received correctly, the receiver wait clock is immediately re-synched and recalibrated. The exception is that when an asynchronous packet is received the clock is immediately re-synched and then subsequently re-calibrated when two consecutive packets have been received. Whatever door state carried by a packet, that is correctly decoded, will be displayed immediately. This includes the system error message of an ‘11’ door state. After these transmissions the RF module is powered down by the MCU to conserve energy, and re-energized when the local timer indicates that another packet is due to arrive.

4. When the receiver has decoded a packet that indicates the door is in transit, the unit will go into continuous listening mode for up to 30 seconds, or the time it takes for four packets to arrive. It is expected that a door in transit will usually hit the opposite end of its travel within 20 seconds of the receipt of one of these packets. At the moment the door hits the fully open or fully closed sensor, the transmitter will send a packet indicating so. When this packet is received, the local wait clock is re-synched and the continuous receive mode is terminated.

5. When the receiver is not receiving packets at the expected times it is assumed that the unit is out of range of the transmitter. There will be a “no signal” indication on the LCD display. The display will also show the last correctly decoded status of the door. The first time an expected packet is not received, and the door is not known to be in the closed state, a beeper is sounded to warn the driver of a potential problem. While out of range, the receiver will continue to listen for packets on the expected schedule. To correct for clocks getting out of synch over an extended separation, the receiver will listen continuously for eleven seconds every six hours to “search” for a packet that may be temporarily displaced. If no correct packet is received during this time, the receiver resumes its previous listening schedule. If packets are received in less than six hours, this eleven-second event will never occur.

System Operation

A. Exiting the Garage

1. Driver initiates garage door opening in some fashion.

2. After the “door closed” sensor is deactivated, on the next scheduled transmission, the transmitter will send the “door in motion” signal.

3. The receiver in the car will display that the door is in transit, and will start listening continuously for the “door open” signal.

4. When the door reaches the fully open position, the “door open” sensor will be activated and the transmitter will immediately send the “door open” signal.

5. Upon receiving this signal, the receiver will display that the door open signal is open and will re-synch its timer.

6. After the vehicle has exited the garage, garage door closing is begun.

7. After the “door open” sensor has been deactivated, on the next scheduled transmission, the transmitter will send the “door in motion” signal.

8. The receiver in the car will display that the door is in transit, and will start listening continuously for the “door closed” signal.

9. When the door reaches the fully closed position, the “door closed” sensor will be activated and the transmitter will immediately send the “door closed” signal.

10. Upon receiving this signal, the receiver will display that the door is closed and will re-synch its timer.

11. The receiver goes to the normal scheduled receiving mode.

B. Entering the Garage

1. Driver initiates the garage door opening in some fashion.

2. After the “door closed” sensor is deactivated, on the next scheduled transmission, the transmitter will send the “door in motion” signal.

3. The receiver in the car will display that the door is in transit, and will start listening continuously for the “door open” signal.

4. When the door reaches the fully open position, the “door open” sensor will be activated and the transmitter will immediately send the “door open” signal.

5. Upon receiving this signal, the receiver will display that the door is open and will re-synch its timer.

6. After the driver has entered the garage, he will initiate the garage door closing.

7. After the “door open” sensor has been deactivated, on the next scheduled transmission, the transmitter will send the “door in motion” signal.

8. The receiver in the car will display that the door is in transit, and will start listening continuously for the “door closed” signal.

9. When the door reaches the fully closed position, the “door closed” sensor will be activated and the transmitter will immediately send the “door closed” signal.

10. Upon receiving this signal, the receiver will display that the door is closed and will re-synch its timer.

11. The receiver goes to the normal scheduled receiving mode.

C. While Parked Inside or Near the Garage

As long as the vehicle is in range of the garage-mounted transmitter, it will listen for and receive the data packets sent every ten seconds. On every packet the receiver clock will be re-synched and re-calibrated. The display will show the current state of the garage door.

D. While out of Range of the Garage Transmitter

1. Data packets are always expected within ten seconds of the last packet received. When a packet is not received on schedule, the receiver will display an out of range message. If the receiver does not have data that the garage door is closed when this occurs, the unit will alert the driver with a short series of beeps.

2. When expected data packets are not received, the unit continues to look for transmissions on the previously established schedule. If the receiver should return to transmitter range, and the clock synchronization has not drifted too far, then the units will immediately re-synch and the “out of range” message is removed from the display on the receiver. The units are designed to maintain synchronization for at least 48 hours while away from each other. If for some reason the clocks are too far out of synch when the transmission returns to within range, the units will not establish communication until the next signal search phase on the six-hour schedule.

3. When the receiver has not received a valid data packet for more than six hours, it will initiate an eleven-second signal search cycle. That is, it will listen for eleven seconds continuously to determine if the transmissions are present but the receiver clock is out of synch. Since the transmitter sends every ten seconds, a packet will be received if the transmitter is in range. If the receiver returns to within range of the transmitter after more than six hours, and the clocks are still adequately synchronized, packet reception will resume immediately. If the clocks are out of synch, packet reception will not resume until the next six-hour search is done.

System Description

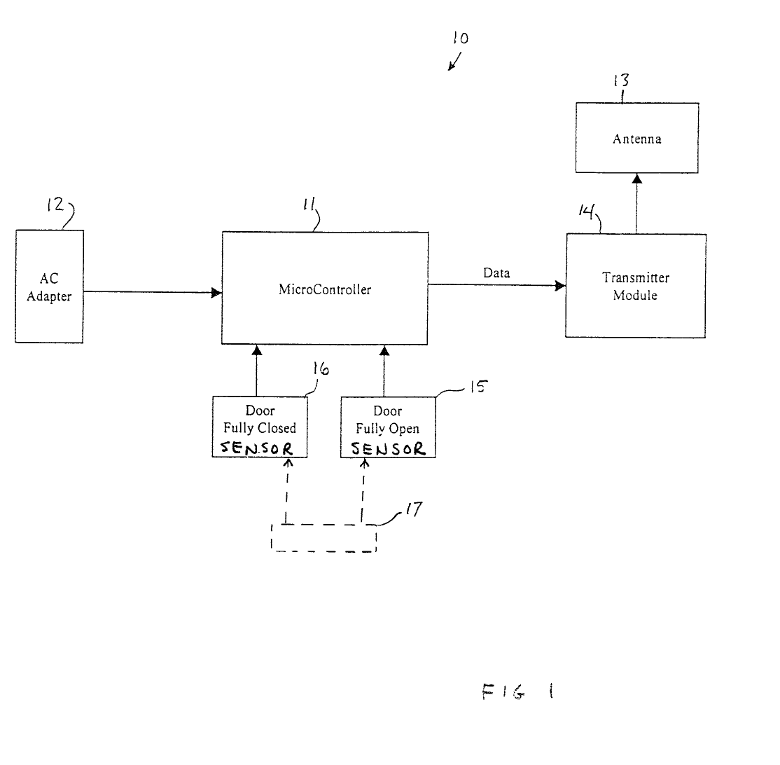

With reference now to the drawings, the transmitter assembly is shown generally at 10 in FIG. 1. Microcontroller 11 receives low voltage AC power from adapter 12 that in turn receives AC power from the home's wiring system (not shown). Alternatively, a battery may be used with an appropriate adapter. Antenna 13 receives signals from transmitter module 14. Garage door 17 (shown in broken line) activates “door open” sensor 15 and “door closed” sensor 16. Sensor 15 and 15 may be any appropriate devices that are preferably inexpensive and weatherproof.

Microcontroller 11 provides data to transmitter module 14 that employs any modulation scheme authorized by FCC regulations.

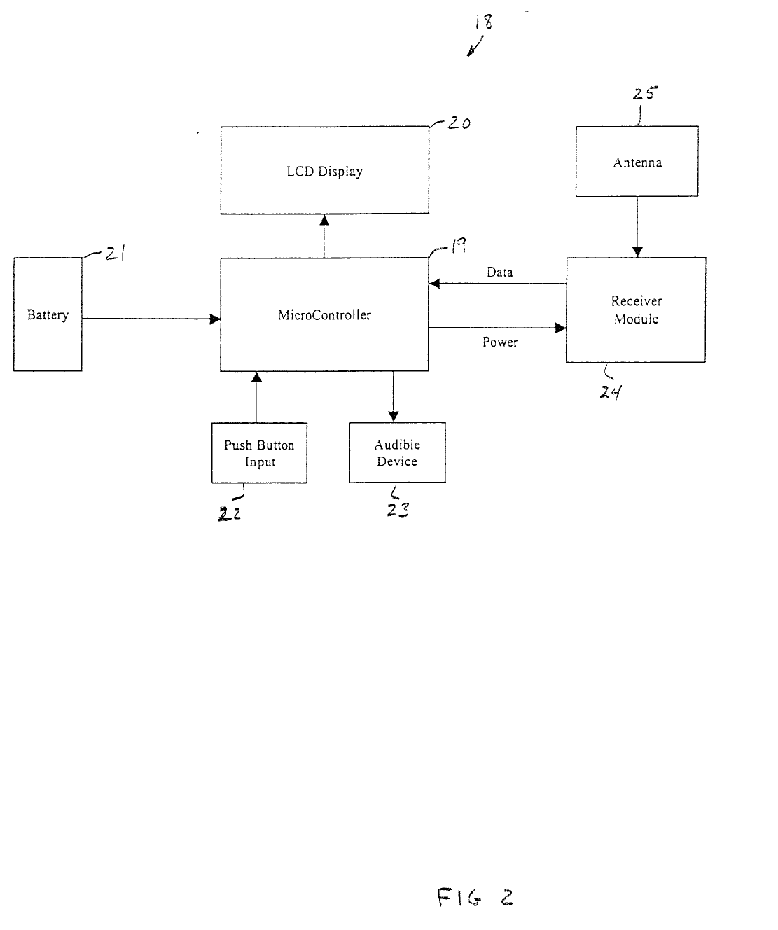

The receiver assembly is shown generally at 18 in FIG. 2. Microcontroller 19 receives power from battery 21 and data from receiver module 24 having antenna 25. The microcontroller 19 has outputs to audible device 23 and LCD display 20. Push button 22 provides an input.

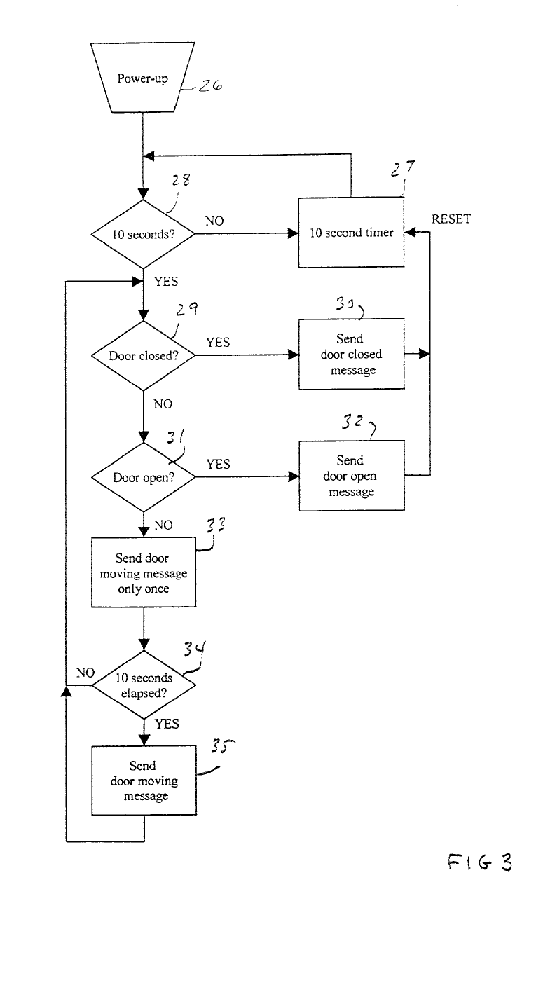

The flow chart for the transmitter assembly 10 is illustrated in FIG. 3. After being turned on by the plugging in of adapter 12 or other appropriate means, assembly 10 powers up at block 26 and waits for ten seconds (block 28) in response to timer 27. After ten seconds, microcontroller 11 checks for inputs from sensors 15 and 16 at blocks 29 and 31 and sends the appropriate output data to transmitter module 14 and also, at blocks 30 and 32, resets the timer 27.

If the door 17 is not fully open or full closed (blocks 29 and 31) a “door in motion” signal is sent at the next scheduled transmission (block 33).

When the door 17 is fully open (block 32) the module 14 will transmit at that time and reset the ten second intervals from the time of that transmission (block 27). When the door 17 is fully closed (block 30) the module 14 will transmit at that time and reset the timer accordingly (block 27).

In the absence of both a fully closed and fully open signal, a “door in motion” signal is sent (blocks 33, 34, 35) during the next scheduled transmission (after the ten second time period).

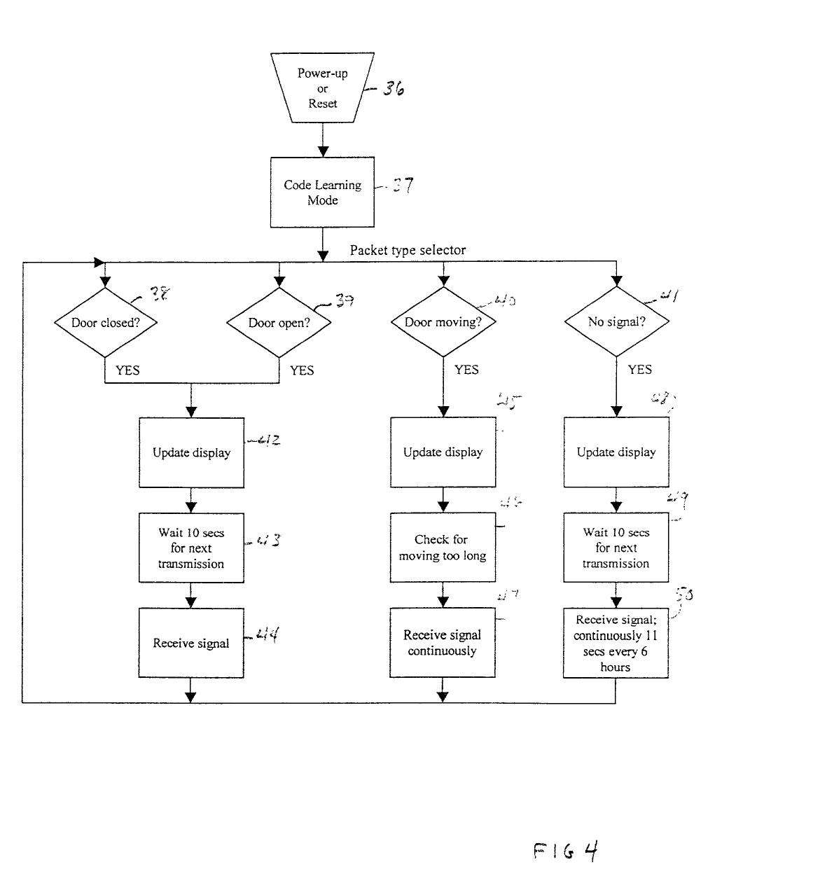

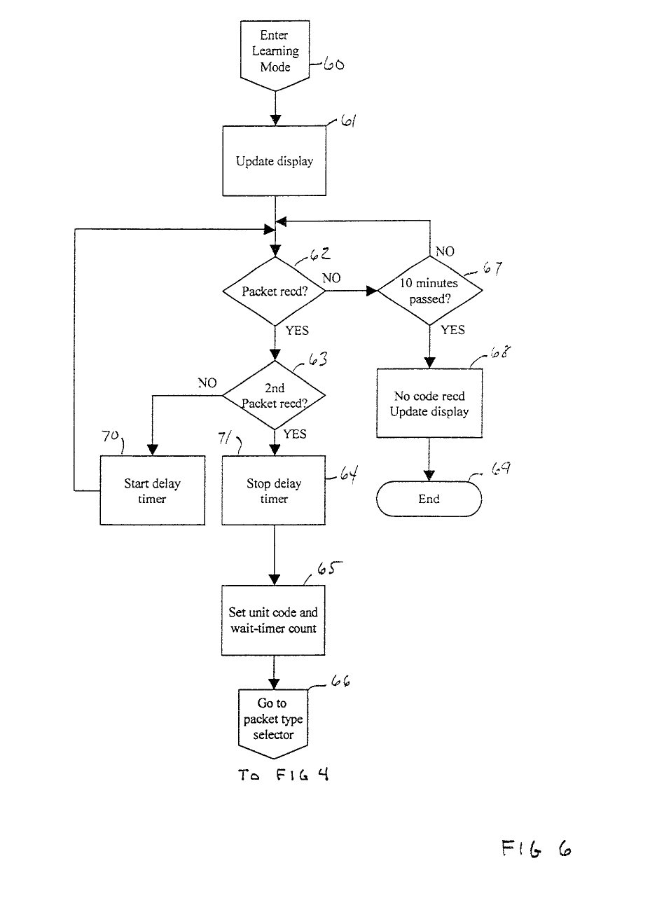

The receiver flow chart is illustrated in FIG. 4. Upon power-up or reset (block 36), receiver 18 will listen for a period of up to ten minutes. When a signal is received that contains the ID number (block 37) chosen for the device, that data is accepted and other data accompanied by a different ID number will be ignored. (See FIG. 6, blocks 60-71)

Upon receipt of a first valid signal, an internal counter is started and runs until a second signal is received. The interval between these two signals, which should be very close to ten seconds, is used for the interval timer of the receiver assembly 18.

Blocks 38-39, 41-44 illustrate receipt of a valid data signal for door “open or “closed” as detected by respective sensors 15 and 16 (FIG. 1). The display 20 is updated every ten seconds if a valid data signal is received.

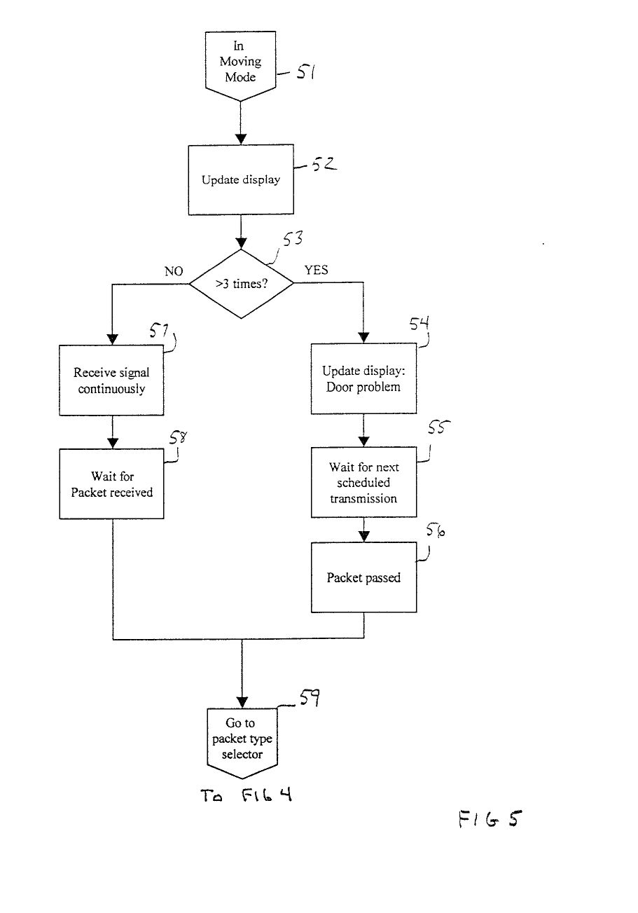

Blocks 40, 45-47 illustrate reception of a “door moving” signal. The receiver 18 will then be energized for thirty seconds, which should be enough time for a garage door 17 to change position. (See FIG. 5, blocks 51-59)

If a signal is not received, the system sends “no signal” (blocks 41, 48, 49) to display 20 and operates on the assumption that the receiver 18 is out of range of transmitter 10.

Audible beeper 23 will sound if a valid signal is not received and door 17 is not indicated as being closed.

At block 50, the receiver 18 will turn on for eleven seconds every six hours to listen for a signal in order to reset the internal clock. If no signal is received the normal listening mode remains operative.

While the invention has been described with respect to certain specific embodiments, it will be appreciated that many modifications and changes may be made by those skilled in the art without departing from the spirit of the invention. It is intended, therefore, by the appended claims to cover all such modifications and changes as fall within the true spirit and scope of the invention.

What is claimed as new and what it is desired to secure by Letters Patent of the United States is:

1. A remote monitoring system for determining and transmitting information indicating the status of a door movable to a plurality of positions comprising sensor means for determining a position of a door and providing an output signal indicative of a position detected, transmitter means responsive to said output signal and repetitively transmitting a broadcast signal indicative of said output signal received, and receiver means for receiving said broadcast signal.

2. The system as defined in claim 1 further including first timer means operatively connected to said transmitter means for selectively controlling periodic transmission of said broadcast signal in accord with first time intervals as established by said first timer means.

3. The system as defined in claim 2 wherein said receiver means includes second timer means for periodically energizing said receiver means at predetermined second time intervals as established by said second timer means to allow for reception of said broadcast signal.

4. The system as defined in claim 3 further including synchronization means for synchronizing the energization of said receiver means with the transmission of said broadcast signal by said transmitter means.

5. The system as defined in claim 4 wherein said synchronizing means includes means for selectively resetting said second timer means to establish said second time intervals to occur substantially simultaneously with said first time intervals.

6. The system as defined in claim 4 wherein said synchronizing means is responsive to the reception of a said broadcast signal by said receiver means, said synchronizing means further including means for selectively resetting said second timer means in response to said reception of said broadcast signal to provide that said second time intervals occur substantially simultaneously with said first time intervals.

7. The system as defined in claim 2 wherein said transmitter means transmits a first said broadcast signal at said first time intervals when said sensor means provides a said output signal indicating that a door is fully open.

8. The system as defined in claim 2 wherein said transmitter means transmits a second said broadcast signal at said first time intervals when said sensor means provides a said output signal indicating that a door is fully closed.

9. The system as defined in claim 2 wherein said transmitter means transmits a third said broadcast signal when said sensor means provides a said output signal indicating that a door is neither fully open nor fully closed.

10. The system as defined in claim 9 wherein said transmitter means transmits said third broadcast signal once after one said first time interval.

11. The system as defined in claim 9 wherein said receiver means includes means for maintaining said receiver means energized for a third time interval after reception of said third broadcast signal by said receiver means.

12. The system as defined in claim 11 wherein said third time interval is a multiple of said first time interval.

13. The system as defined in claim 3 wherein said receiver means has third timer means for establishing third time intervals for selectively energizing said receiver for a third time interval if said broadcast signal is not received by said receiver means for a predetermined time period as established by said receiver means.

14. The system as defined in claim 1 wherein said receiver means includes indicating means responsive to reception of said broadcast signal for indicating a position of a door.

15. The system as defined in claim 14 wherein said indicating means includes audible alarm means for providing an audible alarm if said broadcast signal is not received by said receiver within a predetermined time period and a door is not indicated as being in a predetermined position as established by said receiver means.

16. A method of remotely monitoring the status of a door movable to a plurality of positions comprising the steps of:
A. detecting the position of a door;
B. transmitting a signal indicative of the position detected in step A; and
C. receiving the signal transmitted in step B at a remote location.

17. The method of claim 16 wherein step B includes the step of:
D. periodically transmitting the signal.

18. The method of claim 17 wherein step C includes the step of:
E. periodically enabling the reception of the signal.

19. The method of claim 18 further including the step of:
F. synchronizing the enabling of reception in step E with the transmission of a signal in step D so that the steps occur substantially simultaneously.

20. The method of claim 18 wherein step D includes the step of:
F. periodically energizing a receiver responsive to the signal transmitted in step B.

21. The method of claim 19 wherein step D includes the step of:
G. creating time intervals for periodic transmission in step D with a resettable first timer.

22. The method of claim 21 wherein step G includes the step of:
H. resetting the first timer upon movement of the door to a predetermined position.

23. The method of claim 21 wherein step E includes the step of:
H. creating time intervals that determine when the receiver will be energized with a resettable second timer.

24. The method of claim 23 wherein step F includes the step of:
I. resetting the second timer upon reception of a selected transmitted signal as established by the receiver.

25. The method of claim 16 further including the step of:
D. providing an audible alarm if the door is detected as being open and there has been no reception of a transmitted signal for a predetermined time period.

26. The method of claim 16 further including a step of:
D. indicating the position of a door detected in step A at the remote location of step C.
